(19) United States
(12) Patent Application Publication
(10) Pub. No.: US 2025/0264124 A1
(43) Pub. Date: Aug. 21, 2025

(54) CLAMPING RING FOR SLEEVES

(71) Applicant: WITTENSTEIN SE, Igersheim (DE)

(72) Inventors: Michael Schmidt, Reichenberg (DE); Nikolai Seitz, Gerchsheim (DE); Finn Fellhölter, Würzburg (DE); Thomas Wilhelm, Creglingen-Reinsbronn (DE)

(73) Assignee: WITTENSTEIN SE, Igersheim (DE)

(21) Appl. No.: 19/058,446

(22) Filed: Feb. 20, 2025

(30) Foreign Application Priority Data
Feb. 21, 2024 (DE) 102024104809.3

(51) Int. Cl. F16B 7/04; F16B 7/18

(52) U.S. Cl. CPC F16B 7/0426; F16B 7/182

(57) ABSTRACT

Clamping ring (100), in particular for clamping a sleeve (200) on a shaft, having a receiver (3) for a tensioning screw (33), a radial clamping gap (5) and at least two, and/or a maximum of four, radial elevations (1a-c), wherein the receiver for the tensioning screw and the clamping gap are arranged in one of the radial elevations.

### FIELD OF THE INVENTION

The disclosure relates to a clamping ring for sleeves.

### PRIOR ART

Clamping rings for connecting shafts and sleeves are known from the prior art.

EP 3 642 501 B1 describes a clamping ring with a rounded bulge of the clamping ring for receiving a screw. However, in some applications it is desirable to have an even greater clamping force with small dimensions and a cross section which is as small as possible.

### SUMMARY OF THE INVENTION

It is the object of the invention to specify a clamping ring for connecting a shaft and a sleeve which is improved relative to the prior art. In particular, a clamping ring is intended to be specified for connecting a shaft and a sleeve and a connection, which permit a clamping force which is as high as possible with low mass inertia, good balance quality or low production costs.

The object is achieved by a clamping ring, a connection and a use as disclosed herein.

A first aspect relates to a clamping ring, in particular for clamping a sleeve on a shaft. The clamping ring has a receiving hole for a tensioning screw, a radial clamping gap and at least two, and/or a maximum of four, radial elevations, wherein the receiving hole for the tensioning screw and the clamping gap are arranged in one of the radial elevations.

A further aspect relates to a connection comprising a shaft, a sleeve and a clamping ring according to one of the embodiments described herein, wherein the clamping ring is positioned on the sleeve.

A further aspect relates to a use of a clamping ring according to one of the embodiments described herein for clamping a sleeve on a shaft.

Insofar as hereinafter a list contains “or”, unless specified otherwise “and/or” is understood thereby.

In typical embodiments, the clamping ring comprises at least two, or a maximum of four, radial elevations. In particular, the clamping ring comprises two, three or four radial elevations. In embodiments, not all or none of the radial elevations are symmetrical relative to a radial axis, in particular in the circumferential direction. In particular, at least one of the radial elevations is asymmetrical relative to a radial axis. In embodiments, a plurality of radial elevations, in particular all of the radial elevations, have the same contour. A clamping ring with a plurality of, in particular three, radial elevations advantageously permits a clamping force which is distributed uniformly over the circumference of the clamping ring.

In typical embodiments, a minimum wall thickness of the clamping ring in the radial direction, in particular in a region between two of the radial elevations, is at most 30%, 40%, 50%, 60% or 70% of a maximum wall thickness of the clamping ring in the radial direction, in particular in the region of the radial elevations. In typical embodiments, a local maximum wall thickness of the clamping ring varies between each of the radial elevations by a maximum of 10%, in particular the local maximum wall thickness of the clamping ring is equal in each of the radial elevations. In typical embodiments, a local minimum wall thickness of the clamping ring in indentations or “valleys” varies between each of the radial elevations by a maximum of 10%, in particular the local minimum wall thickness of the clamping ring in indentations or “valleys” is equal between each of the radial elevations. The indentations or “valleys” having a smaller wall thickness advantageously permit, in particular, a deformation of the clamping ring. The radial elevations advantageously permit, in particular, the creation of the clamping force.

In typical embodiments, an axial width of the clamping ring is not greater than 30%, 40%, 50%, 60% or 70% of an internal diameter of the clamping ring.

In typical embodiments, an inner face of the clamping ring on the internal diameter has an at least partially circumferential bearing surface. The bearing surface can have a width in the axial direction of at most 40%, 50%, 60%, or 70% or at least 10%, 20% or 30% of the axial width of the clamping ring. In typical embodiments, the width of the bearing surfaces in the axial direction is at least 10%, 20% and at most 30%, 40% of the internal diameter of the clamping ring. Typically, the bearing surface is configured for bearing against the sleeve. Typically, an edge break is configured by way of example as a chamfer or as a radius on the inner face of the clamping ring. Typically, an edge break is configured at the side, in particular to the left and right, of the bearing surface. In particular, typically the bearing surface advantageously permits a concentration of the clamping force onto a smaller surface of the sleeve and thus makes it possible to reinforce, in particular, the connection between the shaft and sleeve.

In typical embodiments, the clamping ring comprises a radial clamping gap. Typically, at least one of the walls of the clamping gap substantially follows a radial axis. Typically, the radial clamping gap extends along an axis of the clamping gap, in particular along an axis of symmetry of the clamping gap. In typical embodiments, the axis of the clamping gap is a radial axis. In typical embodiments, a width of the clamping gap, in particular in an unmounted state or without exerting a force on the clamping gap, is substantially radially uniform.

In typical embodiments, the radial clamping gap is arranged in the region of one of the radial elevations. In particular, the radial clamping gap is arranged in the region of the local maximum wall thickness of one of the radial elevations.

Typically, the clamping ring comprises exactly one clamping gap. In typical embodiments, the clamping gap is arranged in exactly one radial elevation.

Typically, at least one of the radial elevations, in particular a radial elevation with a clamping gap, has a surface of the outer contour which is parallel to the axis of the clamping gap. Such a surface parallel to the clamping gap can be used as an abutment for a tensioning screw of the clamping ring.

In typical embodiments, the clamping ring comprises a receiving hole for a tensioning element, in particular exactly one receiving hole for a tensioning element. In particular, the clamping ring comprises a bore for receiving a tensioning screw. A central axis of the bore is typically arranged radially closer to the external diameter than to the internal diameter of the clamping ring. The external diameter of the clamping ring is typically the diameter in the region of the maximum wall thickness of the clamping ring. Typically, the central axis of the bore is arranged substantially perpendicularly to a radial axis of the clamping ring. In typical embodiments, the central axis of the bore is arranged substantially perpendicularly to the straight edge of the radial elevation. Typically, the central axis of the bore is arranged substantially perpendicularly to at least one of the walls of the clamping gap. In typical embodiments, the bore has a thread for receiving a tensioning screw.

In embodiments, the clamping ring has a support element, by way of example a support pin, for supporting the tensioning screw, in particular in order to permit a widening or expansion of the clamping ring with the tensioning screw.

Typically, the clamping ring is produced from sheet metal, in particular by means of a laser cutting method, a water jet cutting method or a stamping method. In typical embodiments, the clamping ring can be produced with a contoured outline. Typically the contour of the clamping ring advantageously makes it possible to dispense with an additional balancing step and thus permits a simple and cost-effective production.

In typical embodiments, the clamping ring is positioned on the sleeve, in particular in order to connect the sleeve to the shaft. Typically, the sleeve comprises at least 4 sleeve bores through a lateral surface of the sleeve. In particular, the sleeve comprises 4, 6 or 8 sleeve bores, preferably 6 sleeve bores. Typically, the sleeve bores are through-bores. Typically, all of the sleeve bores have the same diameter. Typically, the sleeve is configured for receiving a motor shaft and is connected to a drive pinion, in particular of a planetary gearset. Typically, the sleeve bores have a greater diameter than the width of the bearing surfaces in the axial direction. In particular, the width of the bearing surfaces in the axial direction is a maximum of 65% or 75% of the diameter of the sleeve bores.

In typical embodiments, the internal diameter of the clamping ring is greater than the external diameter of the sleeve, in particular in the unmounted state. Typically, the diameter of the clamping ring is reduced by tightening the tensioning screw. In particular, the clamping gap is reduced in size.

In embodiments, the internal diameter of the clamping ring in the unmounted state is smaller than the external diameter of the sleeve. In particular, the clamping ring is pretensioned by an oversize and thus can achieve a greater clamping force. Typically, the clamping ring can be expanded for mounting on the sleeve. In particular, the support element can support the tensioning screw in order to expand the clamping ring.

In typical embodiments, the clamping ring is secured against twisting, removal or loss relative to the sleeve, in particular by a securing element. Typically, the clamping ring is secured against an axial or rotational displacement. Advantageously a defined orientation of the clamping ring can be achieved by the securing element, in particular to an adapter plate of a gear unit, in order to ensure by way of example an accessibility of the tensioning screw. Typically, the securing element serves as protection against loss for the clamping ring in an unmounted state of the gear unit on the motor. Typically, the securing element comprises a gap engagement body and a sleeve engagement body, wherein the sleeve engagement body is connected to the gap engagement body, in particular connected in one piece.

Typically, the sleeve engagement body of the securing element engages in one of the sleeve bores, in particular positively. Typically, an internal lateral surface of the sleeve is not passed through by the sleeve engagement body of the securing element. Advantageously, therefore, an insertion of the motor shaft into the sleeve is not limited.

In typical embodiments, the securing element engages in the clamping gap of the clamping ring. In typical embodiments, the gap engagement body of the securing element has a through-hole, in particular for passing through the tensioning screw of the clamping ring. The securing element can advantageously be secured against removal or loss in the clamping gap by the tensioning screw of the clamping ring. In embodiments, the gap engagement body of the securing element has a cutout, which is in particular open on the circumference, for the tensioning screw of the clamping ring. The securing element can be attached or removed through an open cutout independently of the tensioning screw.

In embodiments, the clamping ring comprises a radial clamping ring bore. Typically, the securing element, by way of example a pin or a screw, is inserted into the radial clamping ring bore. Typically, the radial clamping ring bore has a depression or stop surface radially outwardly, in particular in order to ensure a defined penetration depth of the securing element. The securing element engages in one of the sleeve bores without penetrating the internal lateral surface. In embodiments, the securing element is positively connected to one of the sleeve bores. In embodiments, the securing element has a smaller diameter than the sleeve bores, resulting in clearance remaining.

Typically, the securing element is produced from plastics, in particular from a recycled or sustainable, for example compostable, plastics or from sheet metal.

A connection can be achieved by the invention which achieves compact clamping with a high level of clamping force relative to the prior art. By way of example, by the combination of the radial elevations and the thin-walled indentations (or “valleys”), the required clamping force for clamping a motor shaft with a diameter of 19 mm is already achieved with an M4 screw or M5 screw instead of an M6 screw. The invention permits, in particular, a low mass inertia and good balance quality with low production costs. An advantageous protection against rotation and loss is ensured by the securing element for the clamping ring when transported and during handling and operation.

Embodiments can provide particular advantages when clamping the motor shaft in a planetary gearset. In particular, in very compact planetary gearsets with little installation space, the very small axial width of the clamping ring, the small space requirement of the connection and the high clamping force are advantageous.

### BRIEF DESCRIPTION OF THE DRAWINGS

The invention is explained in more detail hereinafter with reference to the accompanying drawings, wherein in the figures:

FIG. 1a shows a clamping ring according to the invention;

FIG. 1b shows the clamping ring of FIG. 1a in a cross section;

FIG. 2a shows a sleeve of a connection according to the invention;

FIG. 2b shows the sleeve of FIG. 2a in a cross section;

FIG. 3a shows a clamping ring, a sleeve and a securing element of a connection according to the invention;

FIG. 3b shows the clamping ring, the sleeve and the securing element of FIG. 3a;

FIG. 4a shows a securing element of a connection according to the invention;

FIG. 4b shows a securing element of a connection according to the invention;

FIG. 4c shows a securing element of a connection according to the invention;

FIG. 4d shows a securing element of a connection according to the invention;

FIG. 5a shows an alternative embodiment of a clamping ring according to the invention; and

FIG. 5b shows the clamping ring of FIG. 5a, a sleeve and an alternative securing element of a connection according to the invention.

### DETAILED DESCRIPTION

Typical exemplary embodiments are described hereinafter by way of the figures, wherein the invention is not limited to the exemplary embodiments. Rather, the scope of the invention is determined by the claims. In the description of the embodiments, in some circumstances, the same reference signs are used for identical or similar parts in the different figures and for different embodiments in order to make the description clearer. This does not mean, however, that corresponding parts of the invention are limited to the variants shown in the embodiments. In some cases, features which have already been described in connection with other figures are not described again for the sake of clarity. In some cases, features which are shown repeatedly in a figure are identified only once by a reference sign.

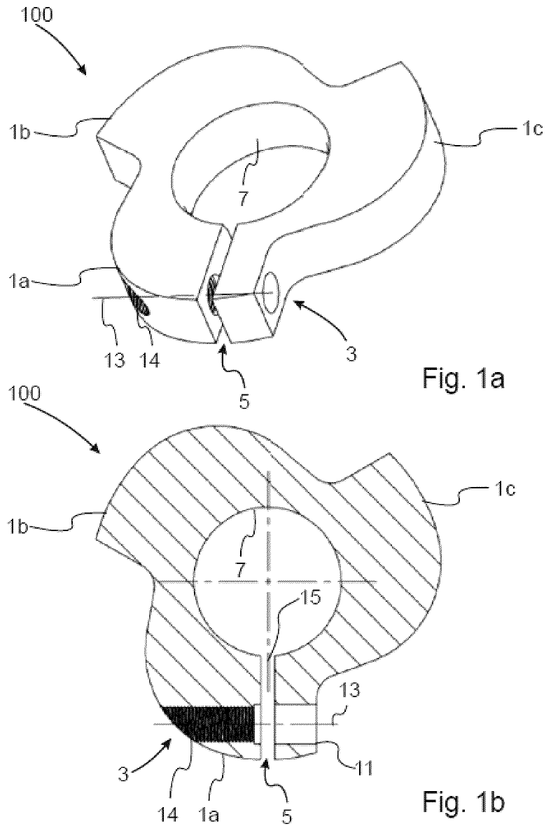

FIG. 1a shows a clamping ring 100 according to the invention. The clamping ring 100 comprises three radial elevations 1a, 1b and 1c, wherein one of the radial elevations 1a comprises a radial clamping gap 5. The radial clamping gap 5 divides one of the radial elevations 1a, in particular on substantially the greatest wall thickness of the radial elevation 1a. Perpendicular to the clamping gap 5 the clamping ring 100 has a receiving hole 3 for a tensioning screw. The receiving hole 3 comprises an internal thread 14 for connecting the tensioning screw to the clamping ring 100. A part of the receiving hole 3 comprises a through-bore. The clamping ring 7 comprises a radially inwardly located internal surface 7.

FIG. 1b shows the clamping ring of FIG. 1a in a cross section. The clamping gap 5 comprises an axis 15 of the clamping gap. The axis 15 of the clamping gap 5 is a radial axis. The radial elevation 1a, which comprises the clamping gap 5, has a surface 11 which is parallel to the axis 15 of the clamping gap 5. The surface 11 is perpendicular to the axis 13 of the receiving hole 3 for the tensioning screw.

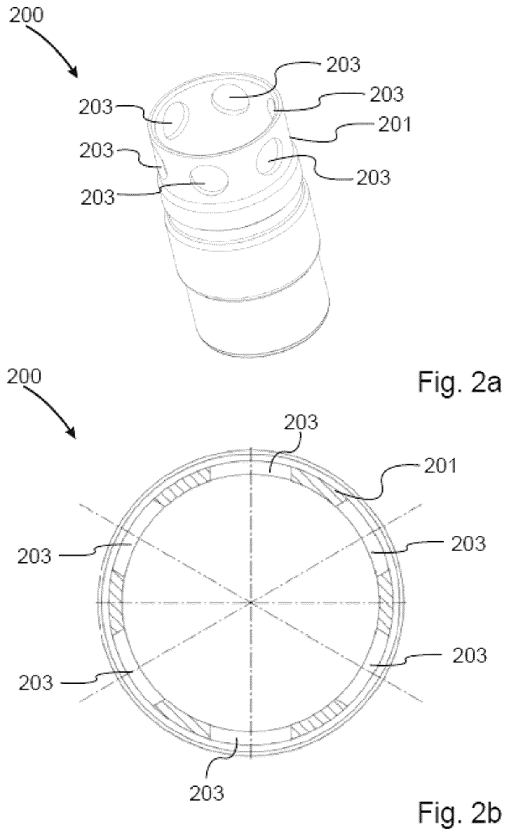

FIG. 2a shows a sleeve 200 of a connection according to the invention. The sleeve 200 comprises six sleeve bores 203 in a lateral surface 201 of the sleeve 200. The sleeve bores 203 are arranged with rotational symmetry, in particular six-fold rotational symmetry, about an axis of the sleeve 200. FIG. 2b shows the sleeve 200 of FIG. 2b in a cross section.

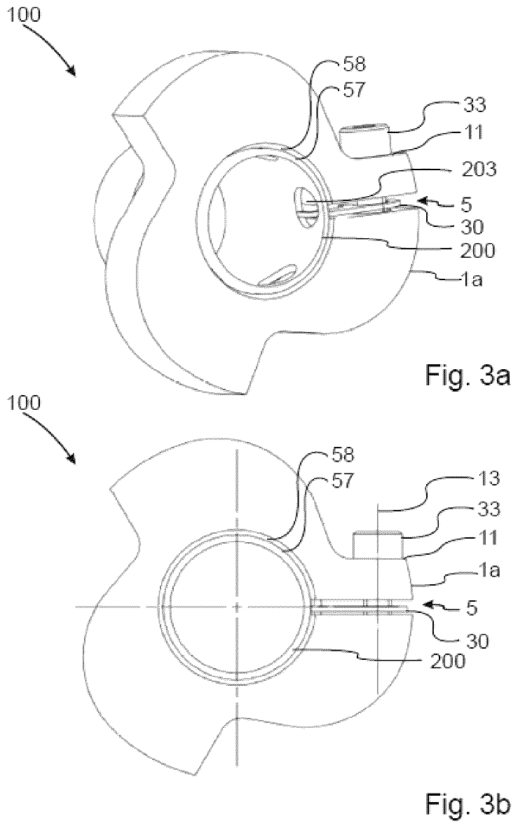

FIG. 3a shows a connection with the clamping ring 100 of FIGS. 1a and 1b and the sleeve 200 of FIGS. 2a and 2b. The inner face 7 of the clamping ring 100 faces the bearing surface 57 of the lateral surface of the sleeve 200. A tensioning screw 33 is introduced into the receiving hole 3. A planar lower face of the screw head of the tensioning screw 33 is positioned on the surface 11 of the outer contour of the clamping ring 100. A securing element 30 is introduced into the radial clamping gap 5. An end of the securing element 30 engages in one of the sleeve bores 203, without penetrating a radially internal lateral surface of the sleeve 200. The tensioning screw 33 engages in the securing element 30. The tensioning screw 33 prevents the securing element 30 from being removed or falling out. In FIG. 3b the connection of FIG. 3a is shown in a plan view. The bearing surface 57 of the clamping ring 100 bears against the lateral surface of the sleeve 200. To the side of the bearing surface an edge break 58 is configured as a chamfer. An axis of the securing element 30 is perpendicular to the axis 13 of the receiving hole of the tensioning screw 33.

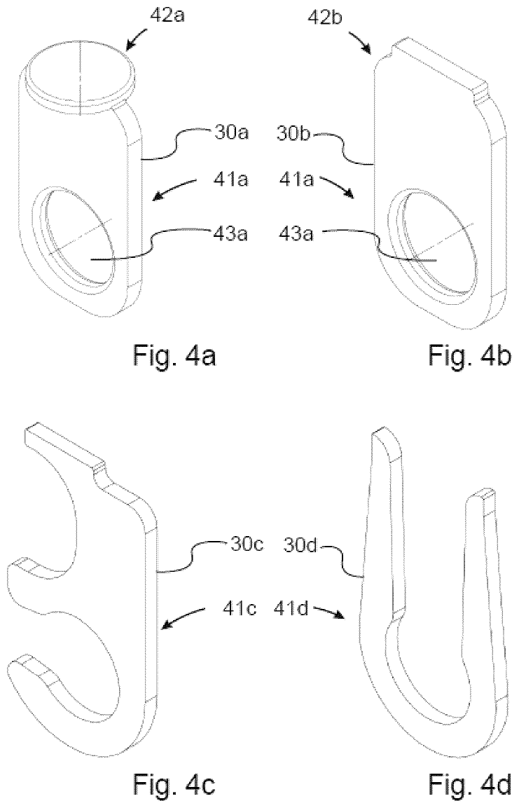

In FIGS. 4a-4d various embodiments of the securing element 30 are shown. In FIG. 4a the securing element 30a comprises a gap engagement body 41a substantially following the clamping gap, with a through-hole 43a and sleeve engagement body 42a. The sleeve engagement body 42a follows the shape of the sleeve bores. In particular, the sleeve engagement body 42a is substantially circular. The sleeve engagement body 42a has in the radial direction a step and an external radius. The external radius of the sleeve engagement body 42a substantially corresponds to a radius of the sleeve bores. In embodiments, the external radius of the sleeve engagement body is smaller than a radius of the sleeve bores.

In FIG. 4b a securing element 30b comprises the gap engagement body 41a of the securing element 30a of FIG. 4a. The securing element 30b comprises a sleeve engagement body 42b flush with the gap engagement body 41a. The sleeve engagement body 42b has in one axis a length which corresponds substantially to a diameter of the sleeve bores. The length of the sleeve engagement body 42b is smaller than a length of the gap engagement body 41a relative to the same axis. The securing elements 30a and 30b are axially symmetrical relative to an axis through the central points of the sleeve engagement body and the through-hole 43a.

In FIG. 4c a securing element 30c comprises a gap engagement body 41c which has two open cutouts. The cutouts are open on one side of the gap engagement body 41c. The contour of the gap engagement body 41c approximately follows the shape of the lower case Greek letter epsilon (E). The contour of the gap engagement body 41c permits an insertion and removal of the securing element 30c independently of the tensioning screw, in particular by lateral insertion along an axial axis of the clamping ring.

In FIG. 4d a securing element 30d comprises a gap engagement body 41d. The gap engagement body 41d is substantially U-shaped, wherein two legs can engage in one of the sleeve bores. The contour of the gap engagement body 41d permits an insertion and removal of the securing element 30d independently of the tensioning screw, in particular by insertion along a radial axis of the clamping ring.

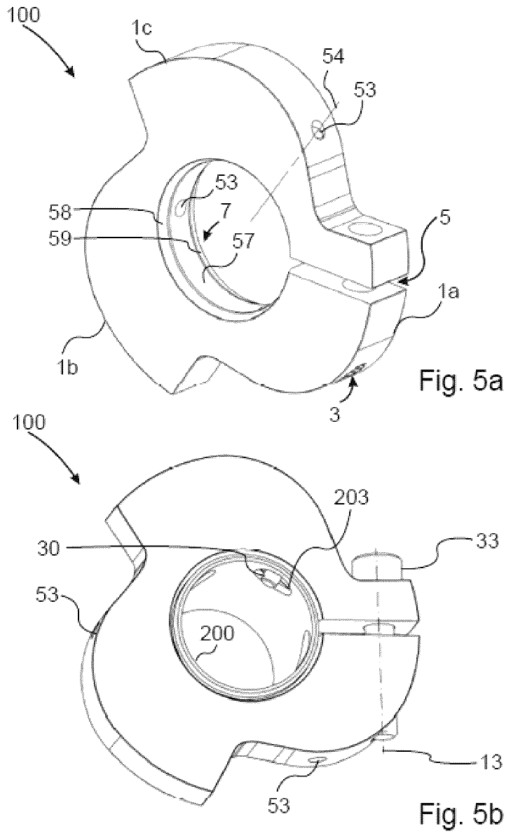

FIG. 5a shows a clamping ring 100 in an alternative embodiment. The clamping ring 100 comprises a circumferential bearing surface 57 on the inner face 7 of the clamping ring 100. Edge breaks 58, 59 in the form of chamfers are configured on the inner face 7 of the clamping ring 100. The edge breaks to the left 58 and right 59 adjoin the bearing surface 57. As a result, the bearing surface has a width of ca. 50% of the axial width of the clamping ring. This leads to a greater surface pressure on the bearing surface and concentrates the clamping force onto the region of the bores in the sleeve. The embodiments of FIGS. 1a, 1b, 3a and 3b can also comprise a circumferential bearing surface 57 on the inner face 7, as shown in FIG. 5a. The clamping ring 100 of FIG. 5a comprises three clamping ring bores 53, wherein each clamping ring bore comprises an axis 54 of the clamping ring bore 53. The axis 54 of the clamping ring bore 53 is a radial axis. In FIG. 5a, each radial elevation 1a, 1b, 1c comprises a clamping ring bore 53. In other embodiments, not shown, only one of the radial elevations 1a, 1b, 1c comprises a clamping ring bore 53.

In FIG. 5b a connection of a clamping ring 100 of FIG. 5a and the sleeve 200 of FIGS. 2a and 2b is shown. A securing element 30 which engages in one of the sleeve bores 203 is inserted into one of the clamping ring bores 53. In the embodiments, not shown, with a connection of the clamping ring 100 of FIG. 5a and the sleeve 200 of FIGS. 2a and 2b, a securing of the clamping ring 100 in one of the clamping ring bores 53 is ensured by the securing element 30.

1. A clamping ring (100) for clamping a sleeve (200) on a shaft, the clamping ring having:
a receiving hole (3) for a tensioning screw (33),
a radial clamping gap (5) and
at least two, and/or a maximum of four,
radial elevations (1a-c),
wherein the receiving hole (3) for the tensioning screw (33) and the clamping gap (5) are arranged in one of the radial elevations (1a).

2. The clamping ring (100) as claimed in claim 1, wherein a minimum wall thickness of the clamping ring (100) in the radial direction is at most 50% of a maximum wall thickness of the clamping ring (100) in the radial direction.

3. The clamping ring (100) as claimed in claim 1, wherein an axis (13) of the receiver (3) of the tensioning screw (33) is arranged closer to an external diameter of the clamping ring (100) than to an internal diameter of the clamping ring (100).

4. The clamping ring (100) as claimed in claim 1, wherein an axial width of the clamping ring (100) is not greater than 50% of the internal diameter of the clamping ring (100).

5. The clamping ring (100) as claimed in claim 1, wherein an inner face (7) of the clamping ring (100) on the internal diameter has an at least partially circulating bearing surface (57) having a width in the axial direction of at most 50% of the axial width of the clamping ring (100).

6. The clamping ring (100) as claimed in claim 1, wherein not all or none of the radial elevations (1a-c) is symmetrical relative to a radial axis.

7. The clamping ring (100) as claimed in claim 1, wherein at least one of the radial elevations (la) has a surface (11) of the outer contour which is parallel to an axis (15) of the clamping gap (5).

8. The clamping ring (100) as claimed in claim 1, wherein the clamping ring (100) is produced from sheet metal.

9. A connection comprising a shaft, a sleeve (200) and a clamping ring (100) as claimed in claim 1, wherein the clamping ring (100) is positioned on the sleeve (200).

10. The connection as claimed in claim 9, wherein the sleeve (200) comprises at least 4 sleeve bores (203) through a lateral surface (201) of the sleeve (200).

11. The connection as claimed in claim 9, wherein the connection comprises a securing element (30, 30a-d) for securing the clamping ring (100) against twisting and/or removal relative to the sleeve (200); and the securing element (30, 30a-d) engages in one of the sleeve bores (203).

12. The connection as claimed in claim 11, wherein the securing element (30, 30a-d) engages in the clamping gap (5) of the clamping ring (100).

13. The connection as claimed in claim 11, wherein the clamping ring (100) comprises a radial clamping ring bore (53); and
the securing element (30, 30a-d) is inserted into the clamping ring bore (53).

14. The connection as claimed in claim 9, wherein the internal diameter of the clamping ring (100) in an unmounted state is smaller than an external diameter of the sleeve (200).

15. A method for clamping a sleeve (200) on a shaft, comprising clamping a clamping ring (100) as claimed in claim 1 on the sleeve (200) which is on the shaft.
